(19) United States
(12) Patent Application Publication
(10) Pub. No.: US 2023/0418654 A1
(43) Pub. Date: Dec. 28, 2023

(54) GENERALIZED MACHINE LEARNING PIPELINE

(71) Applicant: CVS Pharmacy, Inc., Woonsocket, RI (US)

(72) Inventors: Eugenio Zuccarelli, New York, NY (US); Yoon Hyeok Yang, Cambridge, MA (US); Brian R. Lynch, Montclair, NY (US)

(21) Appl. No.: 18/213,062

(22) Filed: Jun. 22, 2023

Related U.S. Application Data
(60) Provisional application No. 63/354,730, filed on Jun. 23, 2022.

(51) Int. Cl. G06F 9/46

(52) U.S. Cl. CPC G06F 9/463

(57) ABSTRACT

A machine learning pipeline includes an input block that receives a dataset from a data source. The dataset includes columns that respectively correspond to different features in the dataset. A feature selection block of the pipeline reduces a size of the dataset by removing a subset of non-correlated features from the dataset, creating a modified dataset having only columns corresponding to correlated features. A model selection block of the pipeline tests performance of a plurality of models against the modified dataset using validation data values. The model selection block selects, from the plurality of models, a candidate model having a measured performance that meets or exceeds measured performances of other models in the plurality of models. An output block of the pipeline provides an output to a computational device that identifies the candidate model as being a preferred model for processing the dataset.

### CROSS-REFERENCE TO RELATED APPLICATIONS

The present application claims the benefit of U.S. Provisional Application Ser. No. 63/354,730 filed Jun. 23, 2022. The entire disclosure of the application listed is hereby incorporated by reference, in its entirety, for all that the disclosure teaches and for all purposes.

### FIELD OF THE DISCLOSURE

The disclosure relates to systems and methods associated with machine learning, and in particular, a machine learning pipeline capable of developing a model capable of predicting a desired target.

### BACKGROUND

Healthcare providers involved in the delivery of treatments to members are able to observe medical histories of their members. Healthcare providers routinely access treatment histories of patients under their care. Techniques are desired for effectively generating strategies (e.g., intervention modalities, medical treatment plans, etc.) for preventing an individual from developing an undesired medical condition.

### SUMMARY

A machine learning pipeline includes: an input block that receives a dataset from a data source, wherein the dataset includes a plurality of columns that each correspond to a different feature in the dataset. The machine learning pipeline, further including a feature selection block that receives the dataset from the input block and reduces a size of the dataset by: dividing features of the dataset into a first subset of features that are correlated features and a second subset of features that are non-correlated features; and removing the second subset of features from the dataset to create a modified dataset having only columns corresponding to the first subset of features. The machine learning pipeline, further including a model selection block that receives the modified dataset from the feature selection block and tests performance of a plurality of models against the modified dataset by feeding one or more validation data values to each of the plurality of models and measuring a performance of each of the plurality of models, wherein the model selection block then selects a candidate model from the plurality of models based on the candidate model having a measured performance that meets or exceeds measured performances of other models in the plurality of models. The machine learning pipeline, further including an output block that provides an output to a computational device that identifies the candidate model as being a preferred model for processing the dataset.

Any of the aspects herein, wherein reducing the size of the dataset further includes: dividing features of the modified dataset into a third subset of features that are predictive of a target variable and a fourth subset of features that are non-predictive features; and removing the fourth subset of features from the dataset to create a second modified dataset including columns corresponding to the third subset of features. Any of the aspects herein, wherein the model selection block receives the second modified dataset from the feature selection block and tests the performance of the plurality of models against the second modified dataset.

Any of the aspects herein, wherein the model selection block further tests the performance of the plurality of models by feeding a previously unseen dataset to each of the plurality of models and measuring the performance of each of the plurality of models.

Any of the aspects herein, wherein the output is delivered in one or more electronic communications to the computational device.

Any of the aspects herein, further including a journey optimization block that receives the modified dataset and identifies one or more interventions for an individual based on processing the modified dataset, wherein the one or more interventions include a recommended set of interventions for the individual.

Any of the aspects herein, wherein the journey optimization block further suggests a communication modality in the output, wherein the communication modality corresponds to a suggested mode for a care provider to communicate the one or more interventions to the individual.

Any of the aspects herein, wherein the feature selection block divides the features of the dataset into the first subset of features and the second subset of features by running an automated correlation analysis.

Any of the aspects herein, wherein the feature selection block runs the automated correlation analysis with a linear regression that uses shrinkage.

Any of the aspects herein, wherein the feature selection block includes a correlation matrix and a Lasso model.

Any of the aspects herein, wherein the feature selection block iteratively processes the modified dataset using the correlation matrix and the Lasso model that forces the non-correlated features to have a value of zero.

Any of the aspects herein, wherein a number of times that the feature selection block iteratively processes the modified dataset is configurable by a user.

Any of the aspects herein, further including a feature engineering block positioned between the input block and the feature selection block, wherein the feature engineering block checks the dataset for errors and fixes any identified errors included in the dataset.

Any of the aspects herein, wherein the feature engineering block enriches the dataset with one or more additional features.

Any of the aspects herein, wherein the one or more validation data values are obtained from the modified dataset.

Any of the aspects herein, further including a parameter setting block that determines one or more operational parameters for the candidate model.

Any of the aspects herein, wherein the feature selection block corresponds to a callable function.

Any of the aspects herein, wherein the model selection block corresponds to a callable function.

Any of the aspects herein, further including: a machine learning model that estimates a target variable; and a Shapley additive explanations (SHAP) model that identifies a percentage of the target variable that is driven by a feature in the first subset of features.

A computer memory device includes a codebase, wherein the codebase provides access to blocks of a machine learning pipeline. The machine learning pipeline includes an input block that receives a dataset from a data source, wherein the dataset includes a plurality of columns that each correspond to a different feature in the dataset. The machine learning pipeline includes a feature selection block that receives the dataset from the input block and produces a modified dataset by dividing features of the dataset into a first subset of features that are correlated features and a second subset of features that are non-correlated features. The machine learning pipeline includes an output block that outputs a candidate model that is optimized to process the first subset of features of the modified dataset and not process the second subset of features of the modified dataset.

Any of the aspects herein, wherein the blocks of the machine learning pipeline further include a model selection block that receives the modified dataset from the feature selection block and tests a performance of a plurality of models against the modified dataset by feeding one or more validation data values to each of the plurality of models and measuring a performance of each of the plurality of models, wherein the model selection block then selects the candidate model from the plurality of models based on the candidate model having a measured performance that meets or exceeds measured performances of other models in the plurality of models.

Any of the aspects herein, wherein the blocks of the machine learning pipeline correspond to callable functions.

All examples, aspects, and features mentioned above can be combined in any technically possible way.

### BRIEF DESCRIPTION OF THE DRAWINGS

The present disclosure is described in conjunction with the appended figures, which are not necessarily drawn to scale:

FIG. 1 illustrates an example of a system in accordance with aspects of the present disclosure.

FIG. 2 illustrates an example of a machine learning pipeline in accordance with aspects of the present disclosure.

FIG. 3 illustrates an example process flow in accordance with aspects of the present disclosure.

### DETAILED DESCRIPTION

Before any examples of the disclosure are explained in detail, it is to be understood that the disclosure is not limited in its application to the details of construction and the arrangement of components set forth in the following description or illustrated in the following drawings. The disclosure is capable of other configurations and of being practiced or of being carried out in various ways. Also, it is to be understood that the phraseology and terminology used herein is for the purpose of description and should not be regarded as limiting.

While various examples of utilizing a machine learning pipeline in association with determining interventions and/or means (e.g. email communications, SMS messages, phone calls, etc.) of intervention for encouraging a member or patient to adhere to a prescribed treatment (e.g., medication) will be described in connection with a member or patient having or potentially susceptible to hypertension, it should be appreciated that the disclosure is not so limited. For instance, it is contemplated that examples of the present disclosure can be applied to determine interventions of many different types for members or patients having any number of different medical conditions that could benefit from care or treatment adherence. In other words, the framework described herein for determining interventions can be leveraged to reduce the risk of any number of different medical conditions. Examples of such medical conditions that can be addressed or improved with the framework described herein include, without limitation, cardiac conditions, diabetes, heightened cholesterol, heightened blood pressure, hypertension, post-operative conditions, pre-operative conditions, cancer and other chronic conditions, infertility, chronic pain, broken bones, torn ligaments, torn muscles, etc.

The terms “member”, “patient”, “subject”, and “individual” may be used interchangeably herein.

High blood pressure (i.e., hypertension) is a medical condition in which the long-term force of blood against the artery walls of an individual is high enough such that the individual may eventually develop health problems such as heart disease. Some approaches for predicting medical conditions of individuals may be unable to accurately and/or successfully predict when an individual will develop such health problems. For example, machine learning and deep learning-based approaches have built upon the abilities of clinicians to assess current complications and predict the future health conditions of an individual. However, among individuals that are potential candidates for hypertension, some healthcare management systems and machine learning-based approaches fail to effectively determine intervention strategies for ensuring that the individual adheres to a corresponding treatment plan.

According to example aspects of the present disclosure, a system supportive of a generalized machine learning Pipeline is described herein. The generalized machine learning pipeline is a machine learning pipeline that supports the processing of information of one or more individuals and a desired target (e.g., a target medical condition). For example, using a series of algorithms, the generalized machine learning pipeline (hereinafter also referred to herein as a machine learning pipeline) may develop a model able to predict the target. In some aspects, the machine learning pipeline may generate and provide actions (e.g., intervention modalities associated with communicating with the individual, proposed medical treatments, etc.) which, if implemented, may reduce the risk of the target.

Aspects of the present disclosure include a scalable approach for any machine learning product that uses regression classification to predict a characteristic about a member and determine an intervention for a member. For example, in some machine learning implementations, many components of a machine learning network end up being re-used. However, in some systems, determining a recommended order of operations to be implemented by the components is a manual process. Aspects of a system described herein support a pipeline of re-usable machine learning blocks that can be configured as needed by a user desiring to make a prediction with respect to a medical condition of a member and determine an appropriate intervention for the member.

In an example, the system may receive a dataset as an input. Each row of the dataset may represent an individual, and each column corresponds to a feature (e.g., age, gender, etc.) of the individual. The dataset further includes a column defined as the “target” column. In an example, the target may include whether the individual will develop a medical condition within a temporal period (e.g., develop hypertension within the following year).

Executing the machine learning pipeline generates a model that is able to estimate the value of the target, given characteristics of an individual associated with the dataset. In some aspects, the system may support providing actionable insights on how to prevent the target from resulting (e.g., prevent the development of the medical condition). For example, the system may output an actionable insight such as “Individual X is expected to develop Hypertension next year, and the main drivers are feature X, Y and Z. We recommend to send an email to the individual informing them to take action.” The system may provide the actionable insight to a device (e.g., a communication device) via an electronic communication.

Example implementations of the machine learning pipeline are described herein. Aspects of features or blocks of the machine learning pipeline that support the example implementations are later described in the following figures. For example, aspects of the example implementations may be performed by a system or components thereof later described herein (e.g., a system 100, a server 135, a communication device 105, processors thereof, etc.).

The machine learning pipeline may receive the dataset as input. The machine learning pipeline may process the dataset using data cleaning and feature engineering operations. For example, the machine learning pipeline may ensure the dataset does not have errors (e.g., through data cleaning). In an example, a feature engineering block of the machine learning pipeline may fill in missing data, fix corrupted data, etc. The feature engineering block may enrich the dataset with potential additional features.

The machine learning pipeline may include feature selection operations supportive of reducing the number of features to be processed by a model (e.g., reducing the number of features needed). For example, the machine learning pipeline may first execute an automatic correlation analysis. The automatic correlation analysis may include operations of highlighting or indicating the most correlated features (e.g., features having a highest correlation coefficient in relation to other features, features correlated to a relatively highest quantity of other features, etc.). The automatic correlation analysis may include operations for retaining (e.g., keeping) features of the dataset and removing other features of the dataset. The retained features may be features determined by the automatic correlation analysis as being the most predictive of the target. In an example, among the features identified as the most correlated features, the machine learning pipeline may retain the correlated features determined as being the most predictive of the target. The machine learning pipeline may remove correlated features determined as relatively less predictive of the target.

Once correlated features and non-correlated features have been identified, in some cases, some non-correlated features of the dataset may be “noise” that fail to add value to a model. For example, some non-correlated features may fail to add value to a model later selected or developed by the machine learning pipeline. In an example, the machine learning pipeline may determine the zip code of an individual as a random numeric value that has no correlation to other features of the dataset and that is not going to add value to the model. Accordingly, for example, the machine learning pipeline may remove such non-correlated features determined as noise.

In some aspects, the machine learning pipeline may remove such non-correlated features using a Lasso model (e.g., a simple Lasso model). The Lasso model may force such non-correlated features to 0. For example, the Lasso model may force correlated coefficients of such non-correlated features to 0. In some aspects, the machine learning pipeline may use the Lasso model in association with removing any features (e.g., highly correlated features, correlated features determined as relatively less predictive of a target, non-correlated features identified as “noise”, etc.) of the dataset.

Once the machine learning pipeline has determined correlated features and non-correlated features of the dataset as described herein (e.g., now that the features are fixed), the machine learning pipeline may select a model type and set of parameters to achieve the desired target. The model type and set of parameters may be, for example, a best model type and a best set of parameters determined by the machine learning pipeline in association with achieving a desired task (e.g., prevention of a medical condition). Selecting the model type and the set of parameters may include an “exploration and exploitation” approach.

For example, the machine learning pipeline may explore all possible models at a relatively high level. In an example, the machine learning pipeline may test models of a model library with a relatively small set of possible values (e.g., a few possible values) to get a high level sense of which model will perform the best among the models. In some examples, the machine learning pipeline may determine which model will perform with the relatively highest accuracy, highest efficiency, etc.

The machine learning pipeline may then use the selected model with the selected parameters (e.g., best model and best parameters), as a baseline, in association with improving the model. For example, taking the parameters of the model, the machine learning pipeline may implement a “fine comb” approach of exploring in the neighborhood of those parameters, looking at values below and above respective baseline values of the parameters (i.e., before and after the baseline values). For example, after the high level exploration of all possible models, the baseline model may generate an output indicating that a parameter (e.g., parameter “X”) has the best baseline value at a value of 0.25. The “fine comb” approach may include using 0.25 as a starting value and exploring values (e.g., 0.24, 0.23, 0.22, 0.26, 0.255, etc.) above and below the starting value. Accordingly, for example, the machine learning pipeline may explore the parameters with a relatively higher level of detail, and the machine learning pipeline may find the exact parameters and/or values thereof that lead to the best model.

The machine learning pipeline may evaluate the performance of the selected model (e.g., best model) on previously unseen data (also referred to herein as a previously unseen dataset). For example, the previously unseen data may be separate from the dataset utilized in association with selecting the model. In some aspects, the machine learning pipeline may receive the previously unseen data as input, but keep the unseen data separate at the feature engineering level (e.g., the machine learning pipeline may refrain from processing the previously unseen data at the feature engineering level). Accordingly, for example, the machine learning pipeline may implement an out-of-sample evaluation, testing the performance of the selected model on the unseen data.

In an example, after testing the model, the machine learning pipeline may pass the model into a Shapley additive explanations (SHAP) model. The SHAP model may support identifying features and percentages thereof that drive a desired target. For example, the SHAP model may provide an output indicating a target value associated with the desired target, a feature driving the target value, and a percentage of the target value as driven by the feature. For example, the SHAP model may provide an output indicating “we expect this individual to have a target value of Y,” and the output may indicate that K % of the value Y is driven by a specific feature (e.g., the individual's failure to take a specific medication, the individual's failure to adhere to a specific treatment action, etc.).

A journey optimization block (also referred to herein as a journey optimizer module) of the machine learning pipeline may process the information output at the SHAP model, together with information including available means of intervention (e.g., email communications, SMS messages, phone calls, etc.). The journey optimization block may assign, from the available means of intervention, a set of interventions to each individual. The journey optimization block may assign the interventions given characteristics of the individual as coming from the SHAP Model. The set of interventions may include interventions determined as the best interventions (e.g., having a highest probability and/or possibility of success) for achieving the desired target. For example, the journey optimization block may provide an output indicating a recommendation to send an email to an individual in association with encouraging the individual (e.g., nudging the individual) to take a specific medication and/or adhere to a specific treatment action. The machine learning pipeline may provide the information output by the journey optimization block to the dataset originally received as input. Accordingly, for example, the machine learning pipeline may enrich the original dataset with the additional information.

The system may provide access to features of the machine learning pipeline via a codebase. In an example, the system may provide the codebase as a series of files to internal users (e.g., data scientists) of the system, giving an ulterior level of flexibility to the internal users. The system may provide the internal users authorization associated with editing or changing the code. Editing or changing the code may include, for example, removing, adding, and/or editing components of the machine learning pipeline. Accordingly, for example, the system may provide internal users the ability to adapt the machine learning pipeline to specific use-cases desired by the internal users. The internal users may wish to edit or change the code, for example, if they disagree with some decisions made within the machine learning pipeline, or if the internal users wish to add, modify, or remove aspects thereof.

Additionally, or alternatively, for external users of the system (e.g., customers, end users, etc.), the system may provide access to features of the machine learning pipeline as implemented by the codebase, with no visibility of the code. For example, aspects of the present disclosure support providing a license to the external users, and based on permissions provided by the system and/or the license, the external users would be able to “call” one or more sections or functionalities of the machine learning pipeline.

Example aspects of the present disclosure are described with reference to the following figures.

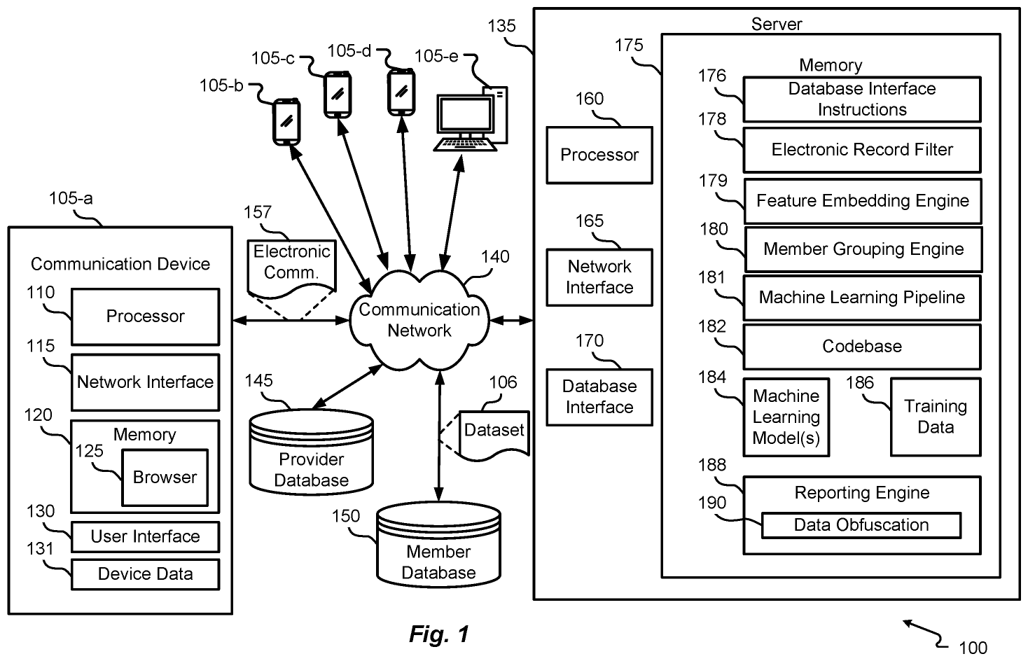

FIG. 1 illustrates an example of a system 100 that supports developing a model capable of predicting a desired target (e.g., a medical condition, hypertension, etc.) in accordance with aspects of the present disclosure. The system 100, in some examples, may include one or more computing devices operating in cooperation with one another to determine intervention strategies for ensuring that an individual adheres to a corresponding treatment plan. The system 100 may be, for example, a healthcare management system.

The components of the system 100 may be utilized to facilitate one, some, or all of the methods described herein or portions thereof without departing from the scope of the present disclosure. Furthermore, the servers described herein may include example components or instruction sets, and aspects of the present disclosure are not limited thereto. In an example, a server may be provided with all of the instruction sets and data depicted and described in the server of FIG. 1. Alternatively, or additionally, different servers or multiple servers may be provided with different instruction sets than those depicted in FIG. 1.

The system 100 may include communication devices 105 (e.g., communication device 105-a through communication device 105-e), a server 135, a communication network 140, a provider database 145, and a member database 150. The communication network 140 may facilitate machine-to-machine communications between any of the communication device 105 (or multiple communication devices 105), the server 135, or one or more databases (e.g., a provider database 145, a member database 150, etc.). The communication network 140 may include any type of suitable communication medium or collection of communication media and may use any type of suitable protocols to transport messages between endpoints. The communication network 140 may include wired communications technologies, wireless communications technologies, or any combination thereof.

The Internet is an example of the communication network 140 that constitutes an Internet Protocol (IP) network consisting of multiple computers, computing networks, and other communication devices located in multiple locations, and components in the communication network 140 (e.g., computers, computing networks, communication devices) may be connected through one or more telephone systems and other means. Other examples of the communication network 140 may include, without limitation, a standard Plain Old Telephone System (POTS), an Integrated Services Digital Network (ISDN), the Public Switched Telephone Network (PSTN), a Local Area Network (LAN), a Wide Area Network (WAN), a wireless LAN (WLAN), a Session Initiation Protocol (SIP) network, a Voice over Internet Protocol (VoIP) network, a cellular network, and any other type of packet-switched or circuit-switched network known in the art. In some cases, the communication network 140 may include of any combination of suitable networks or network types. In some aspects, the communication network 140 may include any combination of suitable communication mediums such as coaxial cable, copper cable/wire, fiber-optic cable, or antennas for communicating data (e.g., transmitting/receiving data).

A communication device 105 (e.g., communication device 105-a) may include a processor 110, a network interface 115, a computer memory 120, a user interface 130, and device data 131. In some examples, components of the communication device 105 (e.g., processor 110, network interface 115, computer memory 120, user interface 130) may communicate over a system bus (e.g., control busses, address busses, data busses) included in the communication device 105. In some cases, the communication device 105 may be referred to as a computing resource. The communication device 105 may establish one or more connections with the communication network 140 via the network interface 115. In some cases, the communication device 105 may transmit or receive packets to one or more other devices (e.g., another communication device 105, the server 135, the provider database 145, the member database 150, etc.) via the communication network 140.

Non-limiting examples of the communication device 105 may include, for example, personal computing devices or mobile computing devices (e.g., laptop computers, mobile phones, smart phones, smart devices, wearable devices, tablets, etc.). In some examples, the communication device 105 may be operable by or carried by a human user. In some aspects, the communication device 105 may perform one or more operations autonomously or in combination with an input by the user.

The communication device 105 may support one or more operations or procedures associated with determining intervention strategies for ensuring that an individual adheres to a corresponding treatment plan. For example, the communication device 105 may support communications between multiple entities such as a data scientist, a healthcare provider, a medical insurance provider, a pharmaceutical manufacturer, a pharmaceutical distributor, a member, a patient, or combinations thereof. In some cases, the system 100 may include any number of communication devices 105, and each of the communication devices 105 may be associated with a respective entity.

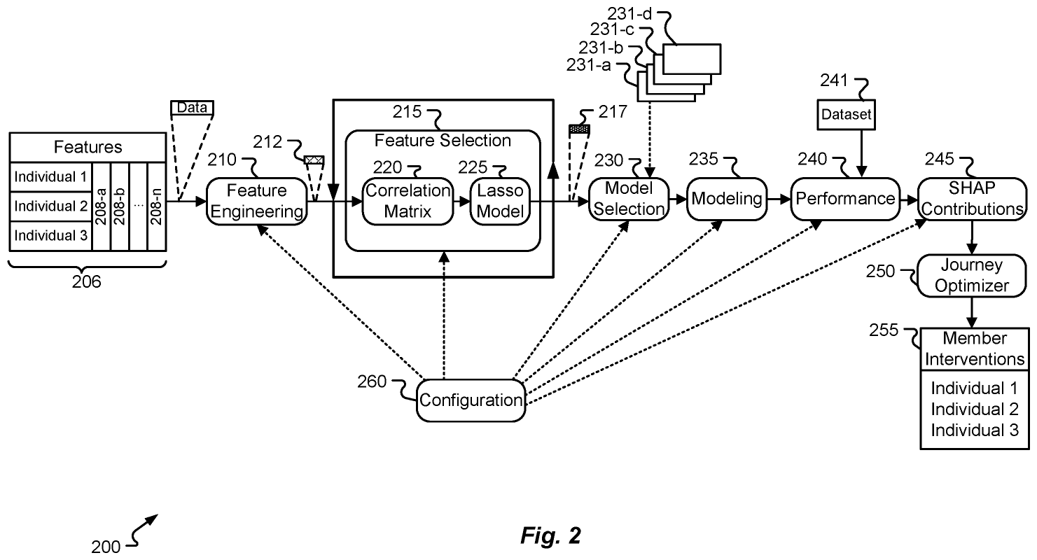

The communication device 105 may render or output any combination of notifications, messages, reports, menus, etc. based on data communications transmitted or received by the communication device 105 over the communication network 140. For example, the communication device 105 may receive one or more electronic communications 157 (e.g., from the server 135) via the communication network 140. In an example, an electronic communication 157 may include an output from the server 135 to the communications device 105 (e.g., a computing device 105 at a medical provider, a communication device 105 of healthcare personnel, etc.). The output may include, for example, interventions and/or communication modalities determined by machine learning pipeline 181, example aspects of which are later described with reference to FIG. 2.

In some aspects, the communication device 105 may render a presentation (e.g., visually, audibly, using haptic feedback, etc.) of the electronic communication 157 via the user interface 130. The user interface 130 may include, for example, a display, an audio output device (e.g., a speaker, a headphone connector), or any combination thereof. In some aspects, the communication device 105 may render a presentation using one or more applications (e.g., a browser application 125) stored on the memory 120. In an example, the browser application 125 may be configured to receive the electronic communication 157 in an electronic format (e.g., in an electronic communication via the communication network 140) and present content of the electronic communication 157 via the user interface 130.

In some aspects, the electronic communication 157 may be a communication including one or more actions for a member that, if followed, are capable of at least partially preventing the development or onset of a medical condition (e.g., hypertension) within a clinically-defined period of time for the member. In some aspects, the electronic communication 157 may include communication modalities which, if implemented by healthcare personnel, may be successful in encouraging the member to follow the one or more actions. In some aspects, the server 135 may communicate the electronic communication 157 to a communication device 105 (e.g., communication device 105-a) of a member, a communication device 105 (e.g., communication device 105-b) of a healthcare provider, a communication device 105 (e.g., communication device 105-c) of an insurance provider, a communication device 105 (e.g., communication device 105-d) of a pharmacist or pharmacy, a communication device 105 (e.g., communication device 105-e) of team outreach personnel, or the like. Additionally, or alternatively, the server 135 may communicate a physical representation (e.g., a letter) of the electronic communication 157 to the member, a healthcare provider, an insurance provider, a pharmacist, team outreach personnel, or the like via a direct mail provider (e.g., postal service).

The provider database 145 and the member database 150 may include member electronic records (also referred to herein as a data records) stored therein. In some aspects, the electronic records may be accessible to a communication device 105 (e.g., operated by healthcare provider personnel, insurance provider personnel, a member, a pharmacist, etc.) and/or the server 135. In some aspects, a communication device 105 and/or the server 135 may receive and/or access the electronic records from the provider database 145 and the member database 150 (e.g., based on a set of permissions). In some aspects, the system 100 may specify accessibility of the electronic records according to authorization levels associated with a user.

In some aspects, an electronic record associated with a member may include claims-based electronic data. For example, the electronic record may include electronic medical record (EMR) data. In another example, the claims-based electronic data may include data describing an insurance medical claim, pharmacy claim, and/or insurance claim made by the member and/or a medical provider. Accordingly, for example, the claims-based electronic data may come from providers or payers, and claims included in the claims-based electronic data may be of various types (e.g., medical, pharmacy, etc.). In some aspects, the electronic record may include demographics information associated with a member, including characteristics such as age, gender, race, and geography, identified using claims data.

In some other aspects, the electronic record associated with the member may include device data 131 obtained from a communication device 105 (e.g., communication device 105-a) associated with the member. For example, the device data 131 may include gyroscopic data, accelerometer data, beacon data, glucose readings, heart rate data, blood pressure data, blood oxygen data, temperature data, kinetics data, location data, motion data, a device identifier, and/or temporal data (e.g., a timestamp) measurable, trackable, and/or providable by the communication device 105 (or a device connected to the communication device 105) associated with the member.

In some aspects, the electronic record may include an image of the member. For example, the electronic record may include imaging data based on which the server 135 (e.g., the care gap management engine 182) may track targeted biomarkers. For example, the server 135 may track diagnostic records and/or images of a member over time. Examples of diagnostic records and/or images include X-ray records, magnetic resonance imaging (MM) scans, computed tomography scans (CT), ultrasound images, or the like.

In an example, the electronic record may include information associated with a structured action plan recorded and/or tracked via an application (e.g., a medical provider application, a diet logging application, an exercise logging application, etc.) executed at the communication device 105. In some aspects, the information associated with the structured action plan may be included in the device data 131. For example, as logged via the application of the communication device 105.

In accordance with aspects of the present disclosure, the device data 131 may be provided continuously, semi-continuously, periodically, and/or based on a trigger condition by the communication device 105 (e.g., a smart watch, a wearable monitor, a self-reporting monitor such as a glucometer, a smartphone carried by a user, etc.) around monitored parameters such as heartbeat, blood pressure, etc. In some aspects, the device data 131 of a communication device 105 (e.g., communication device 105-a) may be referred to as “environmental data” associated with a user, which may be representative of aspects of environmental factors (e.g., lifestyle, socioeconomic factors, details about the environment, etc.) associated with a member.

Accordingly, for example, the electronic record may provide insurance claim information and/or behaviors of member behavior (e.g., behavior common to a set of members). In some cases, the device data 131 may include wearable-device data, glucose readings, heart rate, body temperature, “invisible” data (e.g., device related information associated with a member, such as Bluetooth beacon information), and/or self-reporting monitored data (e.g., provided by self-reporting monitoring devices).

In some aspects, the electronic record may include genetic data associated with a member. In some other aspects, the electronic record may include notes/documentation that is recorded at a communication device 105 in a universal and/or systematic format (e.g., subjective, objective, assessment, and plan (SOAP) notes/documentation) among medical providers, insurers, etc.

In some other aspects, the electronic records may be inclusive of aspects of a member's health history and health outlook. The electronic records may include a number of fields for storing different types of information to describe the member's health history and health outlook. As an example, the electronic records may include personal health information (PHI) data. The PHI data may be stored encrypted and may include member identifier information such as, for example, name, address, member number, social security number, date of birth, etc. In some aspects, the electronic records may include treatment data such as, for example, member health history, member treatment history, lab test results (e.g., text-based, image-based, or both), pharmaceutical treatments and therapeutic treatments (e.g., indicated using predefined healthcare codes, treatment codes, or both), insurance claims history, healthcare provider information (e.g., doctors, therapists, etc. involved in providing healthcare services to the member), in-member information (e.g., whether treatment is associated with care), location information (e.g., associated with treatments or prescriptions provided to the member), family history (e.g., inclusive of medical data records associated with family members of the member, data links to the records, etc.), or any combination thereof. In some aspects, the electronic records may be stored or accessed according to one or more common field values (e.g., common parameters such as common healthcare provider, common location, common claims history, etc.). In some aspects, the system 100 may support member identifiers based on which a server 135 and/or a communication device 105 may access and/or identify key health data per member different from the PHI data.

In some aspects, the server 135 may receive guideline behavior for the member supported by a professional clinical recommendation. The guideline behavior may include actions (e.g., a prescribed drug regimen, a deprescription plan, a structured diet plan, a food regimen, an exercise regimen, etc.) associated with preventing and/or reversing a medical condition of the member. For example, the server 135 may receive and/or access the guideline behavior from a communication device 105, the provider database 145, the member database 150, and/or another server 135. In some examples, the guideline behavior for the member supported by the professional clinical recommendation may include guidance based on at least one of medical history, demographics, social indices, biomarkers, behavior data, engagement data, and a machine learning model-derived output (e.g., as derived by a machine learning model(s) 184 described herein). In some aspects, the guidance may be based on medical history, demographics, social indices, biomarkers, behavior data, engagement data, gap-in-care data, machine learning model-derived output(s), and/or other factors that correspond to the member and/or other members. In some aspects, the server 135 (e.g., using the machine learning pipeline 181) may generate a model capable of determining the guideline behavior.

In some aspects, the provider database 145 may be accessible to a healthcare provider of a member (also referred to herein as a member), and in some cases, include member information associated with the healthcare provider that provided a treatment to the member. In some aspects, the provider database 145 may be accessible to an insurance provider associated with the member. The member database 150 may correspond to any type of known database, and the fields of the electronic records may be formatted according to the type of database used to implement the member database 150. Non-limiting examples of the types of database architectures that may be used for the member database 150 include a relational database, a centralized database, a distributed database, an operational database, a hierarchical database, a network database, an object-oriented database, a graph database, a NoSQL (non-relational) database, etc. In some cases, the member database 150 may include an entire healthcare history or journey of a member, whereas the provider database 145 may provide a snapshot of a member's healthcare history with respect to a healthcare provider. In some examples, the electronic records stored in the member database 150 may correspond to a collection or aggregation of electronic records from any combination of provider databases 145 and entities involved in the member's healthcare delivery (e.g., a pharmaceutical distributor, a pharmaceutical manufacturer, etc.).

The server 135 may include a processor 160, a network interface 165, a database interface 170, and a memory 175. In some examples, components of the server 135 (e.g., processor 160, a network interface 165, a database interface 170, and a memory 175) may communicate via a system bus (e.g., any combination of control busses, address busses, and data busses) included in the server 135. Aspects of the processor 160, network interface 165, database interface 170, and memory 175 may support example functions of the server 135 as described herein. For example, the server 135 may transmit packets to (or receive packets from) one or more other devices (e.g., one or more communication devices 105, another server 135, the provider database 145, the member database 150) via the communication network 140. In some aspects, via the network interface 165, the server 135 may transmit database queries to one or more databases (e.g., provider database 145, member database 150) of the system 100, receive responses associated with the database queries, or access data associated with the database queries.

In some aspects, via the network interface 165, the server 135 may transmit one or more electronic communications 157 described herein to one or more communication devices 105 of the system 100. The network interface 165 may include, for example, any combination of network interface cards (NICs), network ports, associated drivers, or the like. Communications between components (e.g., processor 160, network interface 165, database interface 170, and memory 175) of the server 135 and other devices (e.g., one or more communication devices 105, the provider database 145, the member database 150, another server 135) connected to the communication network 140 may, for example, flow through the network interface 165.

The processors described herein (e.g., processor 110 of the communication device 105, processor 160 of the server 135) may correspond to one or many computer processing devices. For example, the processors may include a silicon chip, such as a Field Programmable Gate Array (FPGA), an Application-Specific Integrated Circuit (ASIC), any other type of Integrated Circuit (IC) chip, a collection of IC chips, or the like. In some aspects, the processors may include a microprocessor, a Central Processing Unit (CPU), a Graphics Processing Unit (GPU), or plurality of microprocessors configured to execute the instructions sets stored in a corresponding memory (e.g., memory 120 of the communication device 105, memory 175 of the server 135). For example, upon executing the instruction sets stored in memory 120, the processor 110 may enable or perform one or more functions of the communication device 105. In another example, upon executing the instruction sets stored in memory 175, the processor 160 may enable or perform one or more functions of the server 135.

The processors described herein (e.g., processor 110 of the communication device 105, processor 160 of the server 135) may utilize data stored in a corresponding memory (e.g., memory 120 of the communication device 105, memory 175 of the server 135) as a neural network. The neural network may include a machine learning architecture. In some aspects, the neural network may be or include one or more classifiers. In some other aspects, the neural network may be or include any machine learning network such as, for example, a deep learning network, a convolutional neural network, or the like. Some elements stored in memory 120 may be described as or referred to as instructions or instruction sets, and some functions of the communication device 105 may be implemented using machine learning techniques. In another example, some elements stored in memory 175 may be described as or referred to as instructions or instruction sets, and some functions of the server 135 may be implemented using machine learning techniques.

In some aspects, the processors (e.g., processor 110, processor 160) may support machine learning model(s) 184 which may be trained and/or updated based on data (e.g., training data 186) provided or accessed by any of the communication device 105, the server 135, the provider database 145, and the member database. The machine learning model(s) 184 may be built and updated by the server 135 based on the training data 186 (also referred to herein as training data and feedback). For example, the machine learning model(s) 184 may be trained with feature vectors of members (e.g., accessed from provider database 145 or member database 150) based on actions of the members in association with adhering to a prescribed medical treatment plan, implemented interventions and communication modalities associated with encouraging the members to follow the medical treatment plan, and corresponding medical outcomes (e.g., resultant changes in a medical condition).

In some aspects, the processors (e.g., processor 110, processor 160) may support implementing a machine learning pipeline 181 capable of developing a model 184 capable of predicting a desired target. Example aspects of developing and implementing the model 184 are described with reference to FIG. 2.

In some aspects, the training data 186 may include multiple training sets. For example, the machine learning model(s) 184 may be trained with a first training set. The first training set may include feature vectors of members (e.g., accessed from provider database 145 or member database 150) for which adherence to one or more actions (e.g., a prescribed drug regimen, a deprescription plan, a structured diet plan, a food regimen, an exercise regimen, etc.) achieved one or more relatively positive impacts (e.g., prevention of a medical condition, reversal of a medical condition, etc.). In an example, the first training set may include feature vectors of members for which adherence to one or more actions prevented the onset of a medical condition or reversed a medical condition.

In an example, the machine learning model(s) 184 may be trained with a second training set that includes feature vectors of members for which a failure to adhere to one or more actions (e.g., a prescribed drug regimen, a deprescription plan, a structured diet plan, a food regimen, an exercise regimen, etc.) resulted in a relatively negative impact (e.g., negative clinical impact, progression to a negative medical diagnosis, etc.).

In another example, aspects of the present disclosure include training the machine learning model(s) 184 with a third training set that includes feature vectors of members (e.g., accessed from provider database 145 or member database 150) for which adherence to one or more actions (e.g., a prescribed drug regimen, a deprescription plan, a structured diet plan, a food regimen, an exercise regimen, etc.) still failed to achieve a target impact (e.g., a positive clinical impact, prevention or reversal of a medical condition, etc.). For example, the third training set may include additional factors (e.g., outside of adherence to the one or more actions) that correlate to the failure to achieve the target impact.

In other examples, the machine learning model(s) 184 may be trained with a fourth training set that includes feature vectors of members for which a set of intervention types (e.g., email, SMS message, telephone calls, etc.) and/or temporal information associated with the interventions (e.g., periodicity, frequency, etc.) resulted in a relatively positive impact (e.g., prevention of a medical condition, reversal of a medical condition, member adherence to a prescribed treatment plan, etc.).

In some other examples, the machine learning model(s) 184 may be trained with a fifth training set that includes feature vectors of members for which a set of intervention types (e.g., email, SMS message, telephone calls, etc.) and/or temporal information associated with the interventions (e.g., periodicity, frequency, etc.) resulted in a resulted in a relatively negative impact (e.g., negative clinical impact, progression to a negative medical diagnosis, failure to adhere to a prescribed treatment plan, etc.).

In some aspects, the machine learning model(s) 184 may be trained with a sixth training set that includes features determined (e.g., by automatic correlation analysis implemented by the machine learning pipeline 181) as being the most predictive of a target.

In some other examples, aspects of the present disclosure include creating a seventh training set based on data included in any of the first through sixth training sets. For example, generating the seventh training set may include identifying a relatively larger set of factors that may affect whether a target impact is achievable.

The machine learning model(s) 184 may be provided in any number of formats or forms. Example aspects of the machine learning model(s) 184, such as generating (e.g., building, training) and applying the machine learning model(s) 184, are described with reference to the figure descriptions herein (e.g., with reference to FIG. 2).

Non-limiting examples of the machine learning model(s) 184 include Decision Trees, gradient-boosted decision tree approaches (GBMs), Support Vector Machines (SVMs), Nearest Neighbor, and/or Bayesian classifiers, and neural-network-based approaches.

In some aspects, he machine learning model(s) 184 may include ensemble classification models (also referred to herein as ensemble methods) such as gradient boosting machines (GBMs). Gradient boosting techniques may include, for example, the generation of decision trees one at a time within a model, where each new tree may support the correction of errors generated by a previously trained decision tree (e.g., forward learning). Gradient boosting techniques may support, for example, the construction of ranking models for information retrieval systems. A GBM may include decision tree-based ensemble algorithms that support building and optimizing models in a stage-wise manner.

According to example aspects of the present disclosure described herein, the machine learning model(s) 184 may include Gradient Boosting Decision Trees (GBDTs). Gradient boosting is a supervised learning technique that harnesses additive training and tree boosting to correct errors made by previous models, or regression trees.

The machine learning model(s) 184 may include extreme gradient boosting (CatBoost) models. CatBoost is an ensemble learning method based on GBDTs. In some cases, CatBoost methods may have improved performance compared to comparable random forest-based methods. CatBoost methods are easily tunable and scalable, offer a higher computational speed in comparison to other methods, and are designed to be highly integrable with other approaches including Shapley Additive Explanations (SHAP) values.

In some aspects, the machine learning model(s) 184 may include ensemble classification models (also referred to herein as ensemble methods) such as random forests. Random forest techniques may include independent training of each decision tree within a model, using a random sample of data. Random forest techniques may support, for example, medical diagnosis techniques described herein using weighting techniques with respect to different data sources.

The memory described herein (e.g., memory 120, memory 175) may include any type of computer memory device or collection of computer memory devices. For example, a memory (e.g., memory 120, memory 175) may include a Random Access Memory (RAM), a Read Only a Memory (ROM), a flash memory, an Electronically-Erasable Programmable ROM (EEPROM), Dynamic RAM (DRAM), or any combination thereof.

The memory described herein (e.g., memory 120, memory 175) may be configured to store instruction sets, neural networks, and other data structures (e.g., depicted herein) in addition to temporarily storing data for a respective processor (e.g., processor 110, processor 160) to execute various types of routines or functions. For example, the memory 175 may be configured to store program instructions (instruction sets) that are executable by the processor 160 and provide functionality of any of the engines (e.g., a feature embedding engine 179, a reporting engine 188, etc.) described herein.

The memory described herein (e.g., memory 120, memory 175) may also be configured to store data or information that is useable or capable of being called by the instructions stored in memory. Examples of data that may be stored in memory 175 for use by components thereof include machine learning model(s) 184 and/or training data 186 described herein.

Any of the engines (e.g., feature embedding engine 179, member grouping engine 180, reporting engine 188, etc.) described herein may include a single or multiple engines.

With reference to the server 135, the memory 175 may be configured to store instruction sets, neural networks, and other data structures (e.g., depicted herein) in addition to temporarily storing data for the processor 160 to execute various types of routines or functions. The illustrative data or instruction sets that may be stored in memory 175 may include, for example, database interface instructions 176, an electronic record filter 178 (also referred to herein as a feature vector filter), and a reporting engine 188. In some examples, the reporting engine 188 may include data obfuscation capabilities 190 via which the reporting engine 188 may obfuscate, remove, redact, or otherwise hide personally identifiable information (PII) from an electronic communication 157 prior to transmitting the electronic communication 157 to another device (e.g., communication device 105).

In some examples, the database interface instructions 176, when executed by the processor 160, may enable the server 135 to send data to and receive data from the provider database 145, the member database 150, or both. For example, the database interface instructions 176, when executed by the processor 160, may enable the server 135 to generate database queries, provide one or more interfaces for system administrators to define database queries, transmit database queries to one or more databases (e.g., provider database 145, member database 150), receive responses to database queries, access data associated with the database queries, and format responses received from the databases for processing by other components of the server 135. For example, the database interface instructions 176 may support aspects of receiving and/or accessing, by the server 135, a dataset 106 from a database (e.g., provider database 145, member database 150). Example aspects of the dataset 106 are described with reference to dataset 206 of FIG. 2.

The server 135 may use the electronic record filter 178 in connection with processing data received from the various databases (e.g., provider database 145, member database 150). For example, the electronic record filter 178 may be leveraged by the database interface instructions 176 to filter or reduce the number of electronic records (e.g., feature vectors) or content thereof as provided to the machine learning pipeline 181. In an example, the database interface instructions 176 may receive a response to a database query that includes a set of feature vectors (e.g., a plurality of feature vectors associated with different members). In some aspects, any of the database interface instructions 176 or the machine learning pipeline 181 may be configured to utilize the electronic record filter 178 to reduce (or filter) the number of feature vectors received in response to the database query, for example, prior to processing data included in the feature vectors.

The feature embedding engine 179 may receive, as input, sequences of medical terms extracted from claim data (e.g., medical claims, pharmacy claims) for each member. In an example, the feature embedding engine 179 may process the input using neural word embedding algorithms such as Word2vec. In some examples, the feature embedding engine 179 may process the input using Transformer algorithms (e.g., algorithms associated with language models such as Bidirectional Encoder Representations from Transformers (BERT) or Generative Pre-trained Transformer (GPT) or graph convolutional transformer (GCT)) and respective attentional mechanisms. In some aspects, based on the processing, the feature embedding engine 179 may compute and output respective dimension weights for the medical terms. In some aspects, the dimension weights may include indications of the magnitude and direction of the association between a medical code and a dimension. In an example, the feature embedding engine 179 may compute an algebraic average of all the medical terms for each member over any combination of dimensions (e.g., over all dimensions). In some aspects, the algebraic average may be provided by the feature embedding engine 179 as additional feature vectors in a predictive model described herein (e.g., classifier).

The member grouping engine 180, when executed by the processor 160, may enable the server 135 to group data records of various members according to a common value(s) in one or more fields of such data records. For example, the member grouping engine 180 may group electronic records based on commonalities in parameters such as health conditions (e.g., diagnosis of a medical condition, prevention or reduction of the medical condition, suggested actions associated with preventing or reducing the medical condition, etc.), interventions and associated impacts, communication modalities of previous communications with the member and associated impacts, medical treatment histories, prescriptions, healthcare providers, locations (e.g., state, city, ZIP code, etc.), gender, age range, medical claims, pharmacy claims, lab results, medication adherence, demographic data, social determinants (also referred to herein as social indices), biomarkers, behavior data, engagement data, historical gap-in-care data, machine learning model-derived outputs, combinations thereof, and the like.

The reporting engine 188, when executed by the processor 160, may enable the server 135 to output one or more electronic communications 157 (and content included therein) based on data generated by any of the feature embedding engine 179, the member grouping engine 180, and the machine learning pipeline 181. The reporting engine 188 may be configured to generate electronic communications 157 in various electronic formats, printed formats, or combinations thereof. Some example formats of the electronic communications 157 may include HyperText Markup Language (HTML), electronic messages (e.g., email), documents for attachment to an electronic message, text messages (e.g., SMS, instant messaging, etc.), combinations thereof, or any other known electronic file format. Some other examples include sending, for example, via direct mail, a physical representation (e.g., a letter) of the electronic communication 157.

The reporting engine 188 may also be configured to hide, obfuscate, redact, or remove PII data from an electronic communication 157 prior to transmitting the electronic communication 157 to another device (e.g., a communication device 105). The reporting engine 188 may also be configured to hide, obfuscate, redact, or remove PII data from an electronic record prior to transmitting the electronic record to another device (e.g., a communication device 105). In some aspects, a communication device 105 may also be configured to hide, obfuscate, redact, or remove PII data from direct mail (e.g., a letter) prior to generating a physical representation (e.g., a printout) of an electronic communication 157 (and/or electronic record). In some examples, the data obfuscation may include aggregating electronic records to form aggregated member data that does not include any PII for a particular member or group of members. In some aspects, the aggregated member data generated by the data obfuscation may include summaries of data records for member groups, statistics for member groups, or the like.

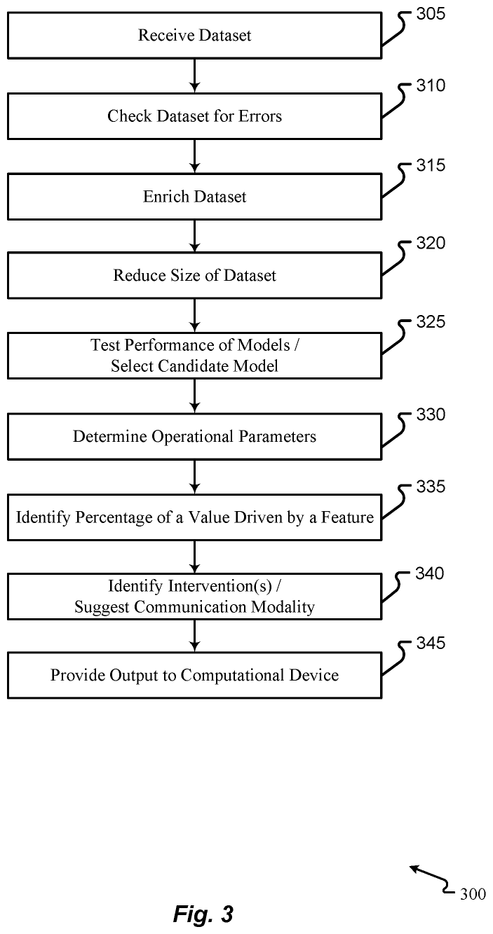

Example illustrative aspects of the system 100 are described with reference to FIGS. 2 and 3. FIG. 2 illustrates an example of a machine learning pipeline 200 in accordance with aspects of the present disclosure. The machine learning pipeline 200 may support techniques associated with enriching a dataset 206 and selecting and/or generating a predictive model. The machine learning pipeline 200 and the dataset 206 may include aspects of like elements described herein described with reference to FIG. 1. Aspects of the machine learning pipeline 200 may be implemented by a server 135 and/or a device 105 described with reference to FIG. 1. Examples of the machine learning pipeline 200 are described herein with reference to FIGS. 1 and 2.

The machine learning pipeline 200 may include an input block (not illustrated), a feature engineering block 210, a feature selection block 215, a model selection block 230, a parameter setting block 235 (also referred to herein as a modeling block), a performance evaluation block 240, a SHAP model 245, a journey optimization block 250, a configuration block 260, and an output block (not illustrated).

The input block may receive a dataset 206 from a data source. The data source may be, for example, a database (e.g., provider database 145, member database 150, etc.), a server (e.g., server 135), or a communication device (e.g., communication device 105).

The dataset 206 may include rows of data and columns 208 (e.g., column 208-a through 208-n, where n is an integer value) of data. In an example, each row may correspond to an individual (e.g., ‘Individual 1’, ‘Individual 2’, etc.), and each column 208 may correspond to a different feature in the dataset 206. That is, for each individual, each column 208 may correspond to different feature of the individual. Example features include for example, age, gender, weight, or other member characteristics as described herein.

The dataset 206 may include a “target” column 208 (e.g., column 208-n). The target column 208 may include an indication of whether an individual will develop a target medical condition within a temporal period. For example, the target column 208 may include an indication of whether the individual will develop hypertension by the following year (e.g., within the following year). In some aspects, the indication may include a binary indication (e.g., yes or no). In some aspects, the indication may be a prediction inclusive of a corresponding probability score and/or confidence score.

The feature engineering block 210 may support data cleaning and feature engineering operations. In an example, the feature engineering block 210 may receive the dataset 206 from the input block. The feature engineering block 210 may evaluate or check the dataset 206 for errors. In some aspects, the feature engineering block 210 may enrich the dataset 206 with one or more additional features (e.g., potential additional features, aspects of which are later described with reference to the feature selection block 215). The feature engineering block 210 may support generating derivative/new features based on the dataset 206.

The feature engineering block 210 may output the dataset 206 (e.g., as checked for errors). Additionally, or alternatively, the feature engineering block 210 may output a dataset 212 (e.g., the dataset 206, as checked for errors and enriched with one or more additional features). For purposes of the example, the description of FIG. 2 refers to further processing of the dataset 206 as received at the feature engineering block 210. However, it is to be understood that aspects of the present disclosure described herein may be similarly applied to the dataset 212.

The feature selection block 215 may receive the dataset 206 from the input block. For example, the feature selection block 215 may receive the dataset 206 from the input block, via the feature engineering block 210. The feature selection block 215 may process the dataset 206 using an automated correlation analysis. In an example, using the automated correlation analysis, the feature selection block 215 may reduce the size of the dataset 206 through one or more operations. In some aspects, in reducing the size of the dataset 206, the feature selection block 215 may reduce the quantity of features included in the dataset 206.

In an example, the feature selection block 215 may divide features of the dataset 206 into multiple subsets of features. The first subset of features may include correlated features. For example, features included in the first subset may be correlated to at least one of other feature in the first subset. The second subset of features may include non-correlated features. For example, features included in the second subset may have no correlation to other features in the dataset 206.

In some aspects, the feature selection block 215 may identify correlations between features of the dataset 206 by using a correlation matrix 220. In some aspects, the correlation matrix 220 may include an indication (e.g., highlighting) of the most correlated features. For example, the correlation matrix 220 may include an indication (e.g., highlighting) of features of the dataset 206 that are correlated to at least a threshold quantity of other features in the dataset 206. In some aspects, using the candidate model 231, the feature selection block 215 may remove features that are duplicative.

In some aspects, the feature selection block 215 may consider a feature to be correlated to another feature if a correlation value associated with the feature is greater than a threshold value (e.g., 0.1, 0.5, etc.). In some other aspects, the feature selection block 215 may consider a feature to be not correlated to another feature if a correlation value associated with the feature is lower than the threshold value (e.g., 0.1, 0.5, etc.).

In some alternative aspects, the feature selection block 215 may consider a feature to be correlated to another feature if a correlation coefficient indicative of the strength of the relationship between the feature and the other feature is included in a threshold range indicating correlation. In an example, the value of the correlation coefficient may range from −1.0 to +1.0, and the threshold range indicating negative correlation may be between −1.0 (relatively strong negative relationship) and −0.6 (e.g., relatively moderate negative relationship). In another example, the threshold range indicating positive correlation may be between +0.6 (e.g., relatively moderate positive relationship) and +1.0 (relatively strong positive relationship). In some other aspects, the feature selection block 215 may consider a feature to have no correlation to another feature if the correlation coefficient of the feature is included in a threshold range (e.g., −0.5 to indicating non-correlation.

The feature selection block 215 may further process the second subset of features using a Lasso model 225. The Lasso model 225 is a linear regression that uses shrinkage. An example of shrinkage includes reducing (or “shrinking”) data values towards a central point. In an example, once the feature selection block 215 has initially divided the features of the dataset 206 into the first subset of features and the second subset of features, some features included in the second subset of features that are not correlated may also be “noise” that would not add value to a model later selected by the model selection block 230. An example of such a feature includes the zip code associated with the individual.

For example, the feature selection block 215 may consider a zip code as noise. The feature selection block 215 may consider a zip code as a random numeric value that has no correlation to other features in the dataset 206. In an example, the Lasso model 225 may force such features (e.g., zip code) considered as noise to have a value (e.g., correlation coefficient) of and the feature selection block 215 may remove such features from the second subset of features. In an alternative example, the feature selection block 215 may consider zip code to be a social determinant of health (e.g., not noise), and the feature selection block 215 may maintain the zip code in the second subset of features.

The feature selection block 215 may remove the second subset of features from the dataset 206. In an example, the feature selection block 215 may create a modified dataset 217 that includes only columns corresponding to the first subset of features.

The feature selection block 215 may support iterative processing. For example, the feature selection block 215 may perform one or more iterations of the automated correlation analysis described herein. In an example, the feature selection block 215 may iteratively process the modified dataset 217 (e.g., using correlation matrix 220 and/or the Lasso model 225). The quantity of iterations associated with processing the modified dataset 217 may be configurable by a user.

Accordingly, for example, the feature selection block 215 may support filtering of features to get rid of features deemed unnecessary or not useful (e.g., non-predictive) by the feature selection block 215. In some other aspects, the feature selection block 215 may remove features which are highly correlated, as models may tend to be confused with highly correlated features. For example, after removing correlated features, the feature selection block 215 does an additional pass removing features that are deemed by the feature selection block 215 as not useful (e.g., non-predictive).

As described herein, the feature selection block 215 may select and maintain the most predictive features (e.g., select one from among a plurality of correlated features), while discarding other features. In some aspects, the feature selection block 215 may incorporate a machine learning decision in association with identifying and selecting which feature will be most predictive among highly correlated features.

The model selection block 230 may utilize the modified dataset 217 to select a candidate model 231-a from a set of models 231 (e.g., model 231-a through model 231-d). For example, the models 231 may be of different model types, and in selecting the candidate model 231, the model selection block 230 is selecting a model type. The set of models 231 may include any suitable quantity of models 231 and any suitable quantity of model types.

In some aspects, selection of a model 231 as described herein supports selection of a particular type of model, which adjusts the model(s) that are used during the model selection process. Model type captures the things that will be repeated, which means that the machine learning pipeline 200 may be implemented without adjusting the codebase when selecting between different model types. Accordingly, for example, aspects of the machine learning pipeline 200 support making changes at the model type-level, without implementing changes at the codebase.

In an example, the model selection block 230 receives the modified dataset 217 from the feature selection block 215. The model selection block 230 may evaluate or test a performance of all (or some) of the models 231 against the modified dataset 217. In an example, the model selection block 230 may feed one or more validation data values included in the modified dataset 217 to each of the models 231 under evaluation and measure a performance of each of the models 231. In some aspects, the model selection block 230 may obtain (e.g., extract) the one or more validation data values from the modified dataset 217.

The dataset 206 may include multiple data subsets, for example, a training dataset, a validation dataset, and a test dataset. Both the validation and test datasets are “hidden” datasets, which may be kept hidden from the models 231 until needed to evaluate the performance thereof. The validation dataset (e.g., modified dataset 217) is used to evaluate the performance. The test dataset (e.g., dataset 241 later described herein) is kept hidden for the entirety of the training pipeline and only used at the end once. In some aspects, the training and validation datasets may be used together in association with a generated model 231. For example, every time a model 231 is generated or created, the model 231 is trained on the training dataset and evaluated on the validation set. The test dataset (e.g., dataset 241) is introduced in association with testing performance of a selected model 231, example aspects of which are later described with reference to performance evaluation block 240.

The model selection block 230 may select a candidate model 231-a based on the measured performance of the models 231. For example, the candidate model 231-a may have a measured performance that meets or exceeds measured performances of other models 231 (e.g., model 231-b through model 231-d). In some examples, the model selection block 230 may evaluate the models 231 based on a list of key performance indicators (KPIs) that define how well a model performs.

In some aspects, the model selection block 230 may assign a score to each of the models 231 based on the measured performances. In an example, the model selection block 230 may select a candidate model 231-a having the highest score among the models 231.

The parameter setting block 235 (also referred to herein as a modeling block) may determine one or more operational parameters for the candidate model 231-a. For example, the parameter setting block 235 explores the candidate model 231-a at a deeper level compared to the model selection block 230. Based on the exploration, the parameter setting block 235 may identify the best coefficients for the candidate model 231-a for processing the dataset 206 in the most efficient/best manner.

In an example, at the parameter setting block 235, the machine learning pipeline 200 decides which correlated feature to choose from the dataset 217. For example, the machine learning pipeline 200 passes the correlated features through a model that will provide a selection of the best correlated feature. The parameter setting block 235 may re-run the feature selection described herein, for example, every time a model 231 is retrained. Further, a model within the machine learning pipeline 200 may support automation of the feature selection process.

The performance evaluation block 240 may evaluate or test the performance of the candidate model 231-a by feeding a previously unseen dataset (e.g., dataset 241) to the candidate model 231-a and measuring the performance of the candidate model 231-a. For example, the dataset 241 may be separate or different from the datasets (e.g., dataset 206, dataset 217) utilized in association with selecting the model. The performance evaluation block 240 may test the performance of the candidate model 231-a using values corresponding to the best correlated feature, as extracted from the dataset 241.

In some aspects, the machine learning pipeline 200 may receive the dataset 241 as input, but keep the dataset 241 separate at the feature engineering level. For example, the machine learning pipeline 200 may refrain from processing the dataset 241 at the feature engineering block 210. Accordingly, for example, the machine learning pipeline 200 may implement an out-of-sample evaluation at the performance evaluation block 240, testing the performance of the candidate model 231-a using the dataset 241.

In an example, the dataset 241 may include correlation values different from those of the datasets (e.g., dataset 206, dataset 217) utilized in association with selecting the candidate model 231-a. The performance evaluation block 240 may test the candidate model 231-a against the dataset 241 (or multiple datasets 241) and plot the performance of the candidate model 231-a across the different values of correlation. Based on the plotted performance, the performance evaluation block 240 may select the best values of correlation, and thereby, determine the best parameters for achieving a desired task (e.g., prevention of a medical condition).

Additionally, or alternatively, the model selection block 230 may implement the operations described herein of the parameter setting block 235 and/or the performance evaluation block 240. For example, the parameter setting block 235 and/or the performance evaluation block 240 may be integrated with the model selection block 230.

The SHAP model 245 identifies a percentage of a particular value being driven by a feature in the first subset of features. For example, the SHAP model 245 may support identifying features and percentages thereof that drive a desired target. For example, the SHAP model 245 may provide an output indicating a target value associated with the desired target, a feature driving the target value, and a percentage of the target value as driven by the feature. For example, the SHAP model 245 may provide an output indicating “we expect this individual to have a target value of Y,” and the output may indicate that K % of the value Y is driven by a specific feature (e.g., the individual's failure to take a specific medication, the individual's failure to adhere to a specific treatment action, etc.).

In some aspects, the SHAP model 245 goes deeper into the data of the dataset 217 compared to models at previous stages of the machine learning pipeline 200. The SHAP model 245 may provide an indication of what background/features are driving a positive health determination and/or a negative health determination.

The journey optimization block 250 may receive the modified dataset 217 and identify one or more interventions for the individual based on processing the modified dataset 217. The journey optimization block 250 may further receive the operational parameters determined by the parameter setting block 235. The interventions may include communicating with an individual in association with encouraging the individual to adhere to a treatment plan (e.g., take a prescribed medication).

In some other aspects, the journey optimization block 250 may determine and provide (e.g., suggest) a communication modality associated with the individual. For example, the communication modality corresponds to a suggested mode for a care provider to communicate with the individual. Example communication modalities include, for example, email communications, SMS messages, phone calls, or the like, but is not limited thereto.

The configuration block 260 may support the configuration of the machine learning pipeline 200. For example, the configuration block 260 may support the configuration and/or editing (e.g., by an internal user of the system 100) of portions of a codebase as described herein. For example, the configuration block 260 may support the configuration of the feature engineering block 210, feature selection block 215, model selection block 230, parameter setting block 235, performance evaluation block 240, and/or SHAP model 245. In some aspects, the configuration block 260 is a data structure (e.g., a file) including a series of configuration parameters. The configuration parameters may include, for example, a desired target for a specific use case. In some aspects, the configuration parameters may include parameters used throughout the machine learning pipeline 200. In an example, the configuration parameters may include target thresholds of correlation. The machine learning pipeline 200 may support any quantity of target thresholds in association with achieving a fine comb approach or a coarser approach of exploring a dataset.

The output block may provide an output to a communication device 105 (e.g., communication device 105-a). The output may include an indication that identifies the candidate model 231-a as being a preferred model for processing the dataset 206. The output may include the interventions and/or communication modality determined by the journey optimization block 250. The interventions and/or communication modality may be included in a dataset 255. In some aspects, the server 135 may deliver the output to the communication device 105 via one or more electronic communications 157.

Accordingly, for example, the machine learning pipeline 200 may provide, in the output, an indication of the candidate model 231-a. The candidate model 231-a is a model 231 that is optimized to process the first subset of features of the modified dataset 217 and not process the second subset of features of the modified dataset 217.

The machine learning pipeline 200 may support adding data (e.g., dataset 255 or a portion thereof) included in the output back into the dataset 206. For example, the machine learning pipeline 200 supports integrating or combining some or all of the dataset 255 into the dataset 206, thereby enriching the dataset 206. For example, by enriching the dataset 206, the machine learning pipeline 200 may achieve improved accuracy with respect to feature selection (e.g., by feature selection block 215), model selection (e.g., by model selection block 230), identifying interventions (e.g., by the journey optimization block 250), and determining and providing communication modalities (e.g., by the journey optimization block 250).

The machine learning pipeline 200 may support calling of any suitable function (e.g., blocks described herein) of the machine learning pipeline 200. That is, for example, the blocks (e.g., feature selection block 215, model selection block 230, etc.) and the operations supported by the blocks correspond to callable functions. The server 135 may provide access to the callable functions via the codebase 182.

In an example, the server 135 may provide users access to features of the codebase based on authorization levels associated with the users. For example, for an internal user of the system 100 (e.g., a data scientist associated with the system 100), the server 135 may provide the codebase 182 as a series of data files in which the internal code is visible to the internal user. The system 100 may support calling of any suitable function (e.g., blocks described herein) of the machine learning pipeline 200 by the internal user. Additionally, or alternatively, the system 100 may support edits to the code by the internal user. Example edits to the code as supported by the system 100 include removal, additions, and edits to blocks (and thereby, functionalities) of the machine learning pipeline 200. The features of editing the code support adapting the machine learning pipeline 200 to specific use-cases desired by the internal user. In some examples, edits to the code may increase processing efficiency, processing speed, and/or accuracy of a machine learning model(s) of the machine learning pipeline 200.

For a user external to the system 100 (also referred to herein as an external user), the server 135 may provide the codebase 182 through a license associated with accessing features of the codebase 182, without providing access to or visibility of the internal code (e.g., through file permissions, data encryption, etc.). In an example, the system 100 may support calling of any suitable function (e.g., blocks described herein) of the machine learning pipeline 200 by the external user. The server 135 may prevent edits to the code by the external user, for example, as the code is not accessible or visible by the external user. In an example implementation, the system 100 may provide a user interface for an external user (e.g., a non-technical user) to input a file with data. The server 135 may process the file through the machine learning pipeline 200 and provide output data (e.g., predicted values, recommended intervention, etc.), without exposing the codebase 182.

In some aspects, the machine learning pipeline 200 may be configurable in that the entirety or portions (e.g., certain blocks) of the machine learning pipeline 200 may be used.

FIG. 3 illustrates an example of a process flow 300 that supports aspects of the present disclosure. In some examples, process flow 300 may implement aspects of a machine learning pipeline 181 or machine learning pipeline 200 described with reference to FIGS. 1 and 2.

In the following description of the process flow 300, the operations may be performed in a different order than the order shown, or the operations may be performed in different orders or at different times. Certain operations may also be left out of the process flow 300, or other operations may be added to the process flow 300.

It is to be understood that while a server 135 may perform a number of the operations of process flow 300, any device (e.g., a communication device 105, another server 135, etc.) may perform the operations shown.

At 305, an input block of a machine learning pipeline receives a dataset (e.g., dataset 106, dataset 206) from a data source (e.g., provider database 145, member database 150, etc.) In some aspects, the dataset may include a plurality of columns that each correspond to a different feature in the dataset.

At 310, a feature engineering block (e.g., feature engineering block 210) positioned between the input and the feature selection block checks the dataset for errors. In some aspects, the feature engineering block may fix any identified errors included in the dataset.

At 315, the feature engineering block enriches the dataset with one or more additional features.

At 320, a feature selection block (e.g., feature selection block 215) receives the dataset from the input and reduces a size of the dataset. In an example, the feature selection block reduces the size of the dataset by: dividing features of the dataset into a first subset of features that are correlated features and a second subset of features that are non-correlated features; and removing the second subset of features from the dataset to create a modified dataset (e.g., modified dataset 217) having only columns corresponding to the first subset of features.

In some aspects, at 320, reducing the size of the dataset by the feature selection block further includes: dividing features of the modified dataset into a third subset of features that are predictive of a target variable and a fourth subset of features that are non-predictive features; and removing the fourth subset of features from the dataset to create a second modified dataset comprising columns corresponding to the third subset of features.

In some aspects, the feature selection block divides the features of the dataset into the first subset of features and the second subset of features by running an automated correlation analysis. In some aspects, the feature selection block runs the automated correlation analysis with a linear regression that uses shrinkage.

In some aspects, the feature selection block may include a correlation matrix (e.g., correlation matrix 220) and a Lasso model (e.g., Lasso model 225). In some aspects, the feature selection block iteratively processes the modified dataset using the correlation matrix and the Lasso model that forces the non-correlated features to have a value of zero.

In some aspects, a number of times that the feature selection block iteratively processes the modified dataset is configurable by a user.

At 325, a model selection block (e.g., model selection block 230) receives the modified dataset from the feature selection block and tests performance of a plurality of models against the modified dataset. In some aspects, the model selection block receives the second modified dataset from the feature selection block and tests the performance of the plurality of models against the second modified dataset.

In an example, at 325, the model selection block tests the performance of the plurality of models by feeding one or more validation data values to each of the plurality of models and measuring a performance of each of the plurality of models. In some aspects, at 325, the model selection block then selects a candidate model from the plurality of models based on the candidate model having a measured performance that meets or exceeds measured performances of other models in the plurality of models.

In some aspects, the model selection block further tests the performance of the plurality of models by feeding a previously unseen dataset to each of the plurality of models and measuring the performance of each of the plurality of models.

In some aspects, the one or more validation data values are obtained from the modified dataset.

At 330, a parameter setting block (e.g., parameter setting block 235) determines one or more operational parameters for the candidate model.

At 335, a SHAP model (e.g., SHAP model 245) identifies a percentage of a target variable that is driven by a feature in the first subset of features. In some aspects, the machine learning pipeline includes a machine learning model that estimates the target variable.

At 340, a journey optimization block (e.g., journey optimization block 250) receives the modified dataset and identifies one or more interventions for an individual based on processing the modified dataset. In some aspects, the one or more interventions comprise a recommended set of interventions for the individual.

In some aspects, the journey optimization block further suggests a communication modality in an output (e.g., an output later provided at 335 by an output block of the machine learning pipeline). In some aspects, the communication modality corresponds to a suggested mode for a care provider to communicate the one or more interventions to the individual.

At 345, the output block provides the output to a computational device (e.g., communication device 105-a). In an example, the output identifies the candidate model as being a preferred model for processing the dataset.

In some aspects, the candidate model is optimized to process the first subset of features of the modified dataset and not process the second subset of features of the modified dataset.

In some aspects, the output is delivered in one or more electronic communications (e.g., electronic communication 157) to the computational device.

In some aspects, the blocks of the machine learning pipeline correspond to callable functions. In an example, the feature selection block corresponds to a callable function. In another example, the model selection block corresponds to a callable function.

A number of implementations have been described. Nevertheless, it will be understood that additional modifications may be made without departing from the scope of the inventive concepts described herein, and, accordingly, other examples are within the scope of the following claims.

The exemplary systems and methods of this disclosure have been described in relation to examples of a communication device 105 and a server 135. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the examples illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed examples, configuration, and aspects.

A number of variations and modifications of the disclosure can be used. It would be possible to provide for some features of the disclosure without providing others.

In yet another example, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another examples, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another example, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the examples with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various examples, configurations, and aspects, includes components, methods, processes, systems and/or apparatus substantially as depicted and described herein, including various examples, subcombinations, and subsets thereof. Those of skill in the art will understand how to make and use the systems and methods disclosed herein after understanding the present disclosure. The present disclosure, in various examples, configurations, and aspects, includes providing devices and processes in the absence of items not depicted and/or described herein or in various examples, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more examples, configurations, or aspects for the purpose of streamlining the disclosure. The features of the examples, configurations, or aspects of the disclosure may be combined in alternate examples, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed example, configuration, or aspect. Thus, the following claims are hereby incorporated into this Detailed Description, with each claim standing on its own as a separate preferred example of the disclosure.

Moreover, though the description of the disclosure has included description of one or more examples, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative examples, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an example that is entirely hardware, an example that is entirely software (including firmware, resident software, micro-code, etc.) or an example combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A machine learning pipeline, comprising:
an input block that receives a dataset from a data source, wherein the dataset comprises a plurality of columns that each correspond to a different feature in the dataset;
a feature selection block that receives the dataset from the input block and reduces a size of the dataset by:
dividing features of the dataset into a first subset of features that are correlated features and a second subset of features that are non-correlated features; and
removing the second subset of features from the dataset to create a modified dataset having only columns corresponding to the first subset of features;
a model selection block that receives the modified dataset from the feature selection block and tests performance of a plurality of models against the modified dataset by feeding one or more validation data values to each of the plurality of models and measuring a performance of each of the plurality of models, wherein the model selection block then selects a candidate model from the plurality of models based on the candidate model having a measured performance that meets or exceeds measured performances of other models in the plurality of models; and
an output block that provides an output to a computational device that identifies the candidate model as being a preferred model for processing the dataset.

2. The machine learning pipeline of claim 1, wherein:
reducing the size of the dataset further comprises:
dividing features of the modified dataset into a third subset of features that are predictive of a target variable and a fourth subset of features that are non-predictive features; and
removing the fourth subset of features from the dataset to create a second modified dataset comprising columns corresponding to the third subset of features; and
the model selection block receives the second modified dataset from the feature selection block and tests the performance of the plurality of models against the second modified dataset.

3. The machine learning pipeline of claim 1, wherein the model selection block further tests the performance of the plurality of models by feeding a previously unseen dataset to each of the plurality of models and measuring the performance of each of the plurality of models.

4. The machine learning pipeline of claim 1, wherein the output is delivered in one or more electronic communications to the computational device.

5. The machine learning pipeline of claim 1, further comprising a journey optimization block that receives the modified dataset and identifies one or more interventions for an individual based on processing the modified dataset, wherein the one or more interventions comprise a recommended set of interventions for the individual.

6. The machine learning pipeline of claim 5, wherein the journey optimization block further suggests a communication modality in the output, wherein the communication modality corresponds to a suggested mode for a care provider to communicate the one or more interventions to the individual.

7. The machine learning pipeline of claim 1, wherein the feature selection block divides the features of the dataset into the first subset of features and the second subset of features by running an automated correlation analysis.

8. The machine learning pipeline of claim 7, wherein the feature selection block runs the automated correlation analysis with a linear regression that uses shrinkage.

9. The machine learning pipeline of claim 1, wherein the feature selection block comprises a correlation matrix and a Lasso model.

10. The machine learning pipeline of claim 9, wherein the feature selection block iteratively processes the modified dataset using the correlation matrix and the Lasso model that forces the non-correlated features to have a value of zero.

11. The machine learning pipeline of claim 10, wherein a number of times that the feature selection block iteratively processes the modified dataset is configurable by a user.

12. The machine learning pipeline of claim 1, further comprising:
a feature engineering block positioned between the input block and the feature selection block, wherein the feature engineering block checks the dataset for errors and fixes any identified errors included in the dataset.

13. The machine learning pipeline of claim 12, wherein the feature engineering block enriches the dataset with one or more additional features.

14. The machine learning pipeline of claim 1, wherein the one or more validation data values are obtained from the modified dataset.

15. The machine learning pipeline of claim 13, further comprising:
a parameter setting block that determines one or more operational parameters for the candidate model.

16. The machine learning pipeline of claim 1, wherein the feature selection block corresponds to a callable function.

17. The machine learning pipeline of claim 1, wherein the model selection block corresponds to a callable function.

18. The machine learning pipeline of claim 1, further comprising:
a machine learning model that estimates a target variable; and
a Shapley additive explanations (SHAP) model that identifies a percentage of the target variable that is driven by a feature in the first subset of features.

19. A computer memory device comprising a codebase, wherein the codebase provides access to blocks of a machine learning pipeline comprising:
an input block that receives a dataset from a data source, wherein the dataset comprises a plurality of columns that each correspond to a different feature in the dataset;
a feature selection block that receives the dataset from the input block and produces a modified dataset by dividing features of the dataset into a first subset of features that are correlated features and a second subset of features that are non-correlated features; and
an output block that outputs a candidate model that is optimized to process the first subset of features of the modified dataset and not process the second subset of features of the modified dataset.

20. The computer memory device of claim 19, wherein the blocks of the machine learning pipeline further comprise:
a model selection block that receives the modified dataset from the feature selection block and tests a performance of a plurality of models against the modified dataset by feeding one or more validation data values to each of the plurality of models and measuring a performance of each of the plurality of models, wherein the model selection block then selects the candidate model from the plurality of models based on the candidate model having a measured performance that meets or exceeds measured performances of other models in the plurality of models.
